(19) United States
(12) Patent Application Publication
(10) Pub. No.: US 2025/0148763 A1
(43) Pub. Date: May 8, 2025

(54) METHOD FOR DIMENSION REDUCTION

(71) Applicants: ROBERT BOSCH GmbH, Stuttgart (DE); CARIAD SE, Wolfsburg (DE)

(72) Inventors: Jared Evans, Sunnyvale, CA (US); Krishnan Bharath Navalpakkam, Milpitas, CA (US); Giacomo Bassetto, Leonberg (DE)

(21) Appl. No.: 18/936,575

(22) Filed: Nov. 4, 2024

(30) Foreign Application Priority Data
Nov. 6, 2023 (DE) 10 2023 130 646.4

(51) Int. Cl. G06V 10/77; G06V 10/75; G06V 10/764; G06V 10/774; G06V 20/58

(52) U.S. Cl. CPC G06V 10/7715; G06V 10/751; G06V 10/764; G06V 20/582; G06V 20/584; G06V 10/774

(57) ABSTRACT

The invention relates to a method (100) for dimension reduction of a multi-dimensional feature space for training a machine learning model (50) by machine learning, comprising the following steps:
providing (101) at least one data pair (30), in which in each case an original data element (31) and a modified data element (32) have a feature difference (Δf) in relation to one another, which feature difference is specific to a respective defined task for machine learning,
determining (102) at least one task-specific feature space, which is specific to the at least one feature difference (Δf), on the basis of a comparison of the respective data pairs (30),
performing (103) the dimension reduction on the basis of the determined task-specific feature space.

The invention relates to a method for dimension reduction of a feature space for training a machine learning model. The invention further relates to a machine learning model, a computer program, a device and a storage medium, each for this purpose.

### STATE OF THE ART

Diversity sampling is a common facet of active learning (see, for example, Yang, Yi, et al. “Multi-class active learning by uncertainty sampling with diversity maximization.” International Journal of Computer Vision, 2015). To select a diverse set of images, the distribution within a high-dimensional feature space is often used. This feature space can be taken from the basic framework of a multitask model or from a pre-trained multi-purpose model, such as “CLIP” (Ramesh, Aditya, et al. “Hierarchical Text-Conditional Image Generation with CLIP Latents”, arXiv:2204.06125 [cs.CV]). Regardless of the origin, these feature spaces are often very high-dimensional. In order to select relevant directions, techniques such as principal component analysis (PCA) are often used to reduce the dimensionality of this space.

PCA efficiently determines and orders the vectors of the feature space over which the data have maximum variance. What produces the highest variance in an image set is likely to be of some interest but does not necessarily correlate with the directions that are most relevant to the underlying tasks of a head—hereafter also referred to as task head—of a multitasking model. Using previous layers from the specific task head as a feature layer may provide some degree of task focus, but the variance in the associated directions may be very low, especially in the case of less frequently occurring objects within the dataset. In a very simplified representation of traffic sign recognition, a feature direction correlated with the presence of yield signs may have much lower variance than others, such as the presence of snow, night, buildings, or vehicles, but focusing on this feature space may be desirable for the selection of appropriately diverse images.

Ideally, the relevant feature space directions can be specified and preselected before applying a dimension reduction technique such as PCA. Using an early layer from a task header as a feature layer can somewhat restrict the directions to the target task.

### DISCLOSURE OF THE INVENTION

The object of the invention is a method having the features of claim 1, a machine learning model having the features of claim 8, a computer program having the features of claim 9, a device having the features of claim 10 and a computer-readable storage medium having the features of claim 11. Further features and details of the invention are apparent from the respective subclaims, the description and the drawings. Features and details which are described in connection with the method according to the invention naturally also apply in connection with the machine learning model according to the invention, the computer program according to the invention, the device according to the invention and the computer-readable storage medium according to the invention, and vice versa in each case, so that reference is or can always be made mutually to the individual aspects of the invention with regard to the disclosure.

The object of the invention is in particular a method for dimension reduction of a multidimensional and preferably high-dimensional feature space, in particular for training a machine learning model by machine learning. The method can comprise providing at least one data pair, in which an original data element and a modified data element (as a data pair) are each provided and/or have a feature difference in relation to one another, which is specific to at least one respective defined task for machine learning. The at least one or more different defined tasks can each be provided by a task head of the machine learning model.

The at least one data pair can also be specific to sensor data resulting from a capture of a sensor such as an image sensor. This means, for example, that the at least one data pair comprises the sensor data from a sensor capture and/or is at least partially based on an image recording of the image sensor and can have corresponding image information. The image information may, for example, comprise images of a vehicle's surroundings that have been captured by the image sensor. The sensor data can therefore comprise, for example, pixels or pixels that represent the captured environment. It is also conceivable that the at least one data pair comprises the sensor data in the form of measurement data, which has been determined by a metrological capture of the sensor. In addition, it may be provided that the at least one data pair is specific to the sensor data in that it comprises at least partially constructed training data that enables the machine learning model to be trained for an application on the sensor data. Various methods can also be combined here, such as augmentation or at least partial simulation of the sensor data. This can have the advantage that the machine learning model is prepared for a variety of situations and environments and therefore has a higher accuracy for the application.

Further, the method may comprise the following steps, which are preferably executed sequentially and/or repeatedly, preferably iteratively for the various of the defined tasks:
determining at least one task-specific feature space, which is specific for the at least one feature difference, on the basis of a comparison of the respective data pairs, wherein preferably the task-specific feature space is implemented as a subspace of the multidimensional and preferably high-dimensional feature space and/or comprises the feature space vectors relevant for the respective task,
performing the dimension reduction on the basis of the determined task-specific feature space.

One advantage of the method is that the relevant feature space vectors can be determined using a simple method. This subspace can then be projected out, e.g. by a deconvolution and preferably a rotation, in order to then apply a PCA to the (reduced) subspace for dimension reduction. In particular, the dimension reduction based on the determined task-specific feature space serves to predetermine and preselect the relevant feature space directions before applying a further dimension reduction technique such as PCA. Alternatively, the implementation of the dimension reduction can already include the implementation of a PCA. The PCA can also provide at least one parameter, such as a transformation result, with which the dimension reduction can also be taken into account in a later application and, in particular, inference of the trained machine learning model.

It is also conceivable within the scope of the invention that the following steps are performed:
training the machine learning model for the at least one defined task on the basis of the dimension reduction performed, wherein the at least one defined task comprises recognizing and/or detecting the at least one feature difference, preferably in the form of classification and/or object detection,
providing the trained machine learning model for an application and preferably inference, in which the at least one defined task is applied to the and/or further sensor data, preferably image data, resulting from a capture of the sensor and/or a further sensor, preferably image sensor.

It may be provided that the values of the sensor data and preferably image data are used to represent a vehicle's surroundings and preferably a traffic scene. At least one of the tasks can also include classification and preferably image classification based on these values, for example to detect objects in the traffic scene. Classification and image classification can also be provided in the form of semantic segmentation (i.e. pixel- or area-based classification) and/or object detection. It is also possible for the application to comprise traffic sign recognition and/or recognition of traffic signals from a traffic light system. Thus, an output of the machine learning model such as a classification result can be used to navigate and/or control an at least partially autonomous robot and/or an at least partially autonomous vehicle taking into account a traffic scene.

Furthermore, within the scope of the invention, it is optionally possible for the data elements provided to be specific to the image data in each case, wherein the at least one feature difference is provided as a difference of an image feature of the image data. Preferably, the recognition of the at least one feature difference (e.g. an object detection) can be performed based on pixel values of the image data. The image data can be, for example, images from a radar sensor, an ultrasonic sensor, a LiDAR sensor and/or a thermal imaging camera. Accordingly, the images can also be radar images and/or ultrasonic images and/or thermal images and/or lidar images.

It is also conceivable in the context of the invention that navigation of an at least partially autonomous robot and/or vehicle is performed on the basis of the recognition and preferably classification and/or object detection, wherein the image data can represent a traffic scene during navigation, wherein the at least one feature difference can be provided as a difference of an image feature of the image data, which indicates a navigation-relevant difference in the traffic scene, preferably in the form of different signals of a traffic light system and/or different traffic signs. In this way, the reliability of such navigation can be improved by dimension reduction and, if necessary, a selection of training data based thereupon.

Preferably, the invention may provide that a transformation result is obtained on the basis of the dimension reduction performed, preferably by applying a principal component analysis, PCA for short, of the reduced feature space. The transformation result can preferably be specific for a weighting or loading of the PCA. The transformation result can be used for dimension reduction of the sensor data when applying the trained machine learning model. For this purpose, the transformation result can be used to form an additional layer in the machine learning model, in particular over a trained neural network of the machine learning model, in order to perform the dimension reduction.

Furthermore, it may be provided that the at least one defined task comprises several different tasks for which the dimension reduction is performed. For this purpose, a specific feature space can be determined in each case. Preferably, the different tasks are provided by different task heads of a machine learning model in order to allow a reliable application, e.g. in an autonomous vehicle.

Furthermore, it is conceivable that the provision of the at least one data pair comprises at least one of the following steps:
masking one of the data elements of the data pair,
replacing a part of one of the data elements with a part of another data element,
performing an in-painting to modify one of the data elements of the data pair.

In this way, a simple method can be used to determine the task-relevant feature space vectors, in which a data element is either masked, replaced by a cut-out part of another data element or painted over. These measures are used to generate two data elements whose difference in the feature space should correlate with the feature difference in the two data elements.

Another object of the invention is a machine learning model trained by a method according to the invention. The machine learning model may, for example, be implemented as a multitasking model which has several task heads in order to provide the various defined tasks.

Another object of the invention is a computer program, in particular a computer program product, comprising instructions which, when the computer program is executed by a computer, cause the computer to execute the method according to the invention. The computer program according to the invention thus has the same advantages as those described in detail with reference to a method according to the invention.

Another object of the invention is a device for data processing which is configured to execute the method according to the invention. The device may, for example, be a computer that executes the computer program according to the invention. The computer may have at least one processor for executing the computer program. A non-transitory data memory may also be provided, in which the computer program is stored and from which the computer program can be read by the processor for execution.

Another object of the invention may be a computer-readable storage medium that contains the computer program according to the invention and/or comprises instructions that, when executed by a computer, cause the computer to execute the method according to the invention. The storage medium is configured, for example, as a data storage device such as a hard disk and/or a non-transitory memory and/or a memory card. The storage medium can, for example, be integrated into the computer.

Furthermore, the method according to the invention may also be implemented as a computer-implemented method.

Further advantages, features and details of the invention are shown in the following description, in which embodiments of the invention are described in detail with reference to the drawings. The features mentioned in the claims and in the description may be essential to the invention individually or in any combination.

The figures show:

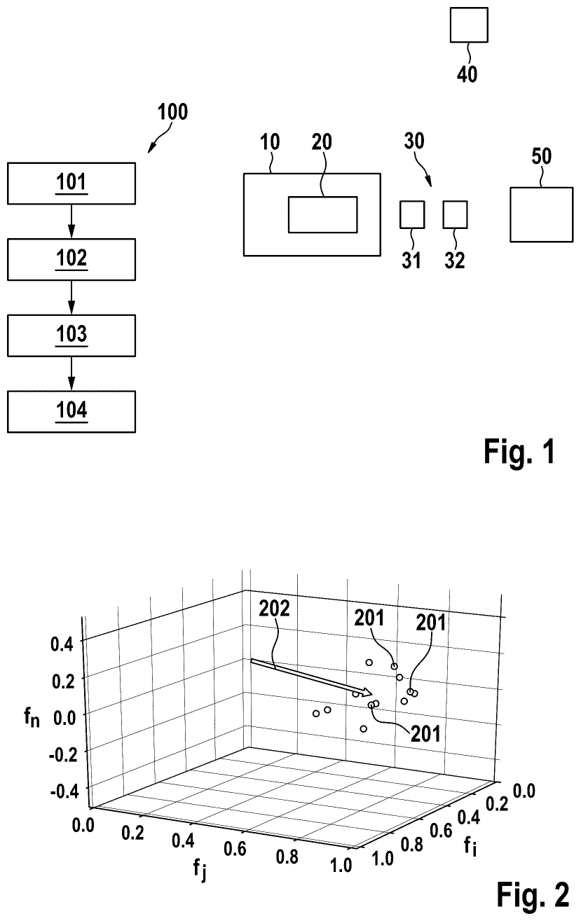

FIG. 1 a schematic visualization of a method, a machine learning model, a device, a storage medium, and a computer program according to embodiments of the invention.

FIG. 2 another illustration for visualizing a method according to embodiments of the invention.

FIG. 1 schematically illustrates a method 100, a device 10, a storage medium 15, a machine learning model 50, and a computer program 20 according to embodiments of the invention.

It is a common problem with machine learning that the feature space of diversity selection and the task of the machine learning model 50 are poorly aligned. Embodiments of the invention can ensure that the diversity selection task is not neglected. The proposed method has the advantage of being simple and intuitive. It can also be applied to multiple tasks and can be easily automated in pipelines once the target images are created.

Embodiments of the invention can be used as an upstream part of a “machine learning toolchain.” Here, a machine learning toolchain can be a collection of software tools that are used in a coordinated process to develop, train, and implement machine learning models. Furthermore, embodiments of the invention can also be used in a navigation of an at least partially autonomous robot and/or vehicle.

According to embodiments of the invention, FIG. 1 illustrates a method 100 for dimension reduction of a multi-dimensional or high-dimensional feature space for training a machine learning model 50. The training may be performed by machine learning, in which in particular one or more defined tasks are learned. The dimension reduction may be performed upstream of the training, in particular in order to prepare the training data for the training. According to a first method step 101, at least one data pair 30 may be provided for this purpose, in which in each case an original data element 31 and a modified data element 32 may have a feature difference Δf in relation to one another, which is specific to the at least one defined task for machine learning. The modified data element 32 may be generated for this purpose on the basis of the original data element 31, for example by modifying the content of the original data element 31. Then, according to a second method step 102, at least one task-specific feature space may be determined, which may (in each case) be a subspace of the original multidimensional feature space of the data pairs. It may be possible for a separate task-specific feature space to be determined for each of the tasks, which may differ from one another. In this way, the respective task-specific feature space can be specific to a feature difference Δf. In order to determine the feature space, a comparison of the respective data pairs 30 may be provided. According to a third method step 104, dimension reduction may be performed based on the (respective) determined task-specific feature space. Furthermore, the machine learning model 50 may be trained 400 for the defined task on the basis of the dimension reduction performed. This enables a trained machine learning model 50 to be provided for an application in which the at least one defined task is applied, for example, to the and/or further sensor data, preferably image data, resulting from a capture of the sensor 40 and/or a further sensor 40, preferably image sensor 40.

In particular, it is an inventive idea to determine the (task-) relevant feature space vectors using a simple method, to project this subspace by rotation and then to apply PCA to the reduced space. As the simple method for determining the relevant feature space vectors, for example, an image may either be masked, replaced by a section from another image or painted over to create two images. These two images comprise the original and the modified one, whose difference in feature space should be correlated with the information difference in the two images. Performing a forward pass through the mesh and extracting the relevant feature space for both images can provide feature space vectors for both the original and the modified image,

$$Δ {\vec{f}}_{i} = {\vec{f}}_{mod , i} - {\vec{f}}_{original , i} .$$

By repeating this process over a small set of several sample images, the normalized mean value of this separation can be obtained,

$$\hat{f} = 〈 {\sum }_{i}^{N} Δ {\vec{f}}_{i} 〉 .$$

This should correspond to a direction in the feature space that is closely linked to this feature, whereby the angle brackets here indicate the normalization to a unit vector. It can then be verified whether the change is meaningfully correlated, i.e.,

$$β = \frac{1}{N} {\sum }_{i}^{N} \hat{f} \cdot 〈 Δ {\vec{f}}_{i} 〉 ,$$

should not be too much smaller than 1, otherwise the correlation f does not correlate meaningfully with the desired feature direction. In these cases, it is likely that the choice of feature space is insensitive to the target or the sensitivity to the target is not sufficiently localized. In some cases, it may make sense to extract more than one feature direction (e.g. a feature hypersurface) for a given target space.

For example, in a picture with a green traffic light, the green traffic light could be replaced with a picture in which the traffic light is yellow. The difference between these two in the feature space, i.e. the feature difference Δfᵢ, should be highly correlated with the exchange of green light for yellow light. If this is repeated with a small number of different example images, the mean value of this separation should roughly indicate the direction of the difference between green and yellow light.

FIG. 2 shows an example of this method according to embodiments of the invention. The points 201 represent the position of the difference vectors between the image pairs in the n-dimensional feature space, e.g. with and without the corresponding object in the image section. The arrow 202 is the fit line, here dominant in the directions fᵢ and fⱼ and with a small component in the other directions (labeled fₙ). The direction of this arrow would be f for the feature highlighted by the image pairs, e.g. a yellow traffic light.

After this task is completed for a single task target, other small image sets can be used to find other desirable features specific to the task head (or desirable features from other task heads). An orthonormal basis can be constructed iteratively by removing the projections in the previous directions, i.e.,

$$\hat{{f}_{i}} = {\vec{f}}_{i} / \vert {\vec{f}}_{i} \vert , {\vec{f}}_{j} = {\vec{{f}^{′}}}_{j} - {\sum }_{i = 1}^{j - 1} {\vec{{f}^{′}}}_{j} \cdot \hat{{f}_{i}}$$

It is possible that the orthonormal basis encounters some redundancy in the vectors when attempting to form the task-specific directions. This can be determined if |\vec{f}ⱼ|<<|\vec{f′}ⱼ|. In this case, the direction can simply be omitted as it is already taken into account by the existing selected directions. Once a set of vectors has been defined and an orthonormal basis has been extracted, the feature space can be rotated. If there are p orthonormal task-specific vectors and q desired basis vectors, the feature space can be rotated as follows,

$${f}^{′} = {R}_{1} f ,$$

so that the first task-specific direction is now aligned with the first direction in the n-dimensional space. This can be repeated iteratively for all p directions so that a single matrix is created,

$$R = {\prod }_{i = 1}^{p} {R}_{i} ,$$

The first p dimensions of the n p-dimensional space are adapted to the target subspace. This matrix can be applied to the feature vectors of all images to perform dimension reduction based on the determined task-specific feature space. Then the PCA can be applied to extract the q−p dimensions with the highest variance from the n-p dimensional subspace. The p orthonormal task-specific directions and the directions with the q−p directions with the highest variance from the PCA within the orthogonal subspace together result in the feature space with reduced diversity, in which task-specific directions are now encoded. In the rotated n-dimensional basis, the PCA matrix is K (q−p)×(n−p) dimensional but can trivially be extended by the p-dimensional identity and use the rotation matrix to form Z=(Iₚ⊕K)·R to form the combined single q×n-matrix, which brings the original feature vectors into the task-specific and PCA directions.

Finally, to ensure that the task-specific feature directions are sufficiently taken into account in the diversity selection, post-selection scaling can be used to obtain unit variance in all directions.

The method described may be used with a selection of pre-processed images to achieve certain task-specific objectives. For example, the following steps may be provided in embodiments of the invention:

First, the feature direction(s) of interest can be extracted from each preselected set of image pairs. Then the resulting orthonormal basis of vectors can be constructed. p vectors can be constructed. The rotation matrix R can be determined and applied to all images in the data set. A PCA can then be performed, removing the first p dimensions are removed to obtain the q−p PCA directions. Then the identity can be expanded to obtain Z and an extraction of the reduced dimensional space can be performed. After scaling to the unit normal, a diversity sampling algorithm of choice can be applied.

This setup can also be done online. Once the model is trained and the above steps have been performed, the modified PCA may be set as the weights of a linear neural network layer associated with the model. In this way, the transformation result can be used when applying the machine learning model. During inference, the cost of extracting these feature vectors is very low. High positive values of the corresponding feature directions can be used for online triggering.

The above description of the embodiments describes the present invention only in the context of examples. Of course, individual features of the embodiments may be freely combined with one another, provided that this is technically expedient, without departing from the scope of the present invention.

1. A method for dimension reduction of a multidimensional feature space for training a machine learning model by machine learning, comprising the following steps:
providing at least one data pair, in which in each case an original data element and a modified data element have a feature difference (Δf) in relation to one another, which feature difference is specific to a respective defined task for machine learning, the at least one data pair being specific to sensor data resulting from a capture of a sensor,
determining at least one task-specific feature space, which is specific to the at least one feature difference (Δf), on the basis of a comparison of the respective data pairs,
performing the dimension reduction on the basis of the determined task-specific feature space.

2. The method of claim 1,
characterized in that
the following steps are performed:
training the machine learning model for the at least one defined task on the basis of the dimension reduction performed, wherein the at least one defined task comprises recognizing the at least one feature difference (Δf), preferably in the form of classification and/or object detection,
providing the trained machine learning model for an application in which the at least one defined task is applied to the and/or further sensor data, preferably image data, resulting from a capture of the sensor and/or a further sensor, preferably image sensor.

3. The method of claim 2,
characterized in that
the data elements are each specific to the image data, wherein the at least one feature difference (Δf) is provided as a difference of an image feature of the image data, and the recognition of the at least one feature difference is performed on the basis of pixel values of the image data.

4. The method of claim 2,
characterized in that
the navigation of an at least partially autonomous robot and/or vehicle is performed on the basis of the recognition and preferably classification and/or object detection, wherein the image data represent a traffic scene during navigation, wherein the at least one feature difference (Δf) are provided as a difference in an image feature of the image data which indicates a navigation-relevant difference in the traffic scene, preferably in the form of different signals of a traffic light system and/or different traffic signs.

5. The method of claim 2,
characterized in that
a transformation result is obtained based on the performed dimension reduction, preferably by an application of a principal component analysis (PCA) of the reduced feature space, wherein the transformation result is preferably specific to a weighting or loading of the principal component analysis, wherein the transformation result is used in the application of the trained machine learning model for dimension reduction of the sensor data.

6. The method of claim 1,
characterized in that
the at least one defined task comprises a plurality of different tasks for which the dimension reduction is performed, wherein a feature space specific thereto is determined for this purpose in each case, wherein preferably the different tasks are provided by different task heads of a machine learning model.

7. The method of claim 1,
characterized in that
the provision of the at least one data pair comprises at least one of the following steps:
Masking one of the data elements of the data pair,
Replacing a part of one of the data elements with a part of another data element,
Performing an in-painting to modify one of the data elements of the data pair.

8. (canceled)

9. (canceled)

10. A device for data processing configured to execute computing instructions that cause the device to:
provide at least one data pair, in which in each case an original data element and a modified data element have a feature difference (Δf) in relation to one another, which feature difference is specific to a respective defined task for machine learning, the at least one data pair being specific to sensor data resulting from a capture of a sensor,
determine at least one task-specific feature space, which is specific to the at least one feature difference (Δf), on the basis of a comparison of the respective data pairs,
perform the dimension reduction on the basis of the determined task-specific feature space.

11. A computer-readable storage medium, comprising instructions which, when executed by a computer, cause it to:
provide at least one data pair, in which in each case an original data element and a modified data element have a feature difference (Δf) in relation to one another, which feature difference is specific to a respective defined task for machine learning, the at least one data pair being specific to sensor data resulting from a capture of a sensor,
determine at least one task-specific feature space, which is specific to the at least one feature difference (Δf), on the basis of a comparison of the respective data pairs,
perform the dimension reduction on the basis of the determined task-specific feature space.
